(19) United States
(12) Patent Application Publication
(10) Pub. No.: US 2026/0280999 A1
(43) Pub. Date: Sep. 17, 2026

(54) CONTROL OF CONTENT DISTRIBUTION NODE

(71) Applicant: Bytedance Technology Ltd., Grand Cayman (KY)

(72) Inventors: Xin Zhong, Singapore (SG); Wei Zeng, Beijing (CN); Songkai Jia, Beijing (CN); Zhenlong Xu, Beijing (CN); Jingbang Liu, Los Angeles, CA (US); Baicheng Xin, Beijing (CN); Lan Xie, Beijing (CN); Dian Yang, Singapore (SG); Yuli Liu, Beijing (CN); Hanmin Qi, Beijing (CN); Chonghao Huang, Beijing (CN)

(21) Appl. No.: 19/213,937

(22) Filed: May 20, 2025

Related U.S. Application Data
(63) Continuation of application No. PCT/SG2025/050179, filed on Mar. 13, 2025.

(51) Int. Cl. H04L 41/147

(52) U.S. Cl. CPC H04L 41/147

(57) ABSTRACT

The embodiment of the disclosure provides a method, apparatus, device and a storage medium for controlling a content distribution node. The method includes the following steps: determining a predicted network traffic of the content distribution node within a predetermined time period; determining, based on the predicted network traffic, a content distribution mode of the content distribution node for the predetermined time period, wherein the content distribution mode includes at least a first mode; based on determining that the content distribution mode of the content distribution node is the first mode, and receiving a content access request from a terminal device, transmitting, via the content distribution node and to the terminal device, a first content item corresponding to the content access request, and restraining the content distribution node from transmitting at least one second content item to be presented after the first content item to the terminal device.

### CROSS-REFERENCE

This application is a continuation of and claims priority to International Patent Application No. PCT/SG2025/050179, filed on Mar. 13, 2025, entitled “METHOD, APPARATUS, DEVICE, STORAGE MEDIUM AND PROGRAM PRODUCT FOR CONTROLLING CONTENT DISTRIBUTION NODE”, the entirety of which is incorporated herein by reference.

### FIELD

Example embodiments of the present disclosure generally relate to the field of computers, and in particular, to control of content distribution node.

### BACKGROUND

With the development of Internet information technology, network content has become an important carrier for information dissemination, entertainment and leisure, and business activities. In order to improve loading speed of network content and shorten loading time, provider of some network content selects to utilize a content delivery network (CDN) system for content distribution. CDN systems are typically charged by a network traffic (e.g., downstream network traffic) generated by the provider. In this case, it is necessary to control the network traffic to give consideration to both quality of experience (QoE) and return on investment (ROI).

### SUMMARY

In a first aspect of the present disclosure, a method for controlling a content distribution node is provided. The method comprises: determining a predicted network traffic of the content distribution node within a predetermined time period; determining, based on the predicted network traffic, a content distribution mode of the content distribution node for the predetermined time period, wherein the content distribution mode comprises at least a first mode; based on determining that the content distribution mode of the content distribution node is the first mode, and receiving a content access request from a terminal device, transmitting, via the content distribution node and to the terminal device, a first content item corresponding to the content access request, and restraining the content distribution node from transmitting at least one second content item to be presented after the first content item to the terminal device.

In a second aspect of the present disclosure, an apparatus for controlling a content distribution node is provided. The apparatus comprises: a predicting module configured to determine a predicted network traffic of the content distribution node within a predetermined time period; a determining module configured to determine, based on the predicted network traffic, a content distribution mode for the content distribution node in the predetermined time period, wherein the content distribution mode comprises at least a first mode; a controlling module configured to, based on determining that the content distribution mode of the content distribution node is the first mode, and receiving a content access request from a terminal device, transmit, via the content distribution node and to the terminal device, a first content item corresponding to the content access request, and restrain the content distribution node from transmitting at least one second content item to be presented after the first content item to the terminal device.

In a third aspect of the present disclosure, an electronic device is provided. The apparatus comprises at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer readable storage medium having computer-executable instructions stored thereon which are executable by a processor to implement the method of the first aspect.

In a fifth aspect of the present disclosure, a computer program product is provided. The computer program product comprises computer-executable instructions, wherein the computer-executable instructions, when executed by a processor, implement the method according to the first aspect of the present disclosure.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF THE DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIG. 2 shows a flowchart of a process of controlling a content distribution node according to some embodiments of the present disclosure;

FIG. 3 illustrates a schematic structural block diagram of an example apparatus for controlling a content distribution node according to some embodiments of the present disclosure; and

FIG. 4 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it is to be understood that the present disclosure may be implemented in various forms, and should not be interpreted as limited to the embodiments set forth herein, on the contrary, these embodiments are provided for a more thorough and complete understanding of the present disclosure. It is to be understood that the drawings and embodiments of the present disclosure are merely for exemplary purposes and are not intended to limit the scope of the present disclosure.

In the description of the embodiments of the present disclosure, the terms “comprising” and the like should be understood as openness, i.e., “comprising but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

Herein, unless explicitly stated, “in response to A” performs one step and does not imply that this step is performed immediately after “A”, but may include one or more intermediate steps.

It may be understood that the data involved in the technical solution (including but not limited to the data itself, the obtaining or usage of the data) should follow the requirements of the corresponding laws and regulations and related regulations.

It may be understood that, before the technical solutions disclosed in the embodiments of the present disclosure are used, the user should be informed of types, usage scope, usage scenarios and the like of personal information related to the present disclosure, and an authorization of the user should be acquired in an appropriate manner and according to the relevant laws and regulations.

For example, in response to receiving an active request from a user, prompt information is sent to the user to explicitly prompt the user that the requested operation will need to obtain and use personal information of the user, so that the user can autonomously select whether to provide personal information to software or hardware such as electronic devices, applications, server or storage media that perform the operation of the technical solution of the present disclosure according to the prompt information.

As an optional but non-limiting implementation, in response to receiving an active request of the user, a manner of sending prompt information to the user may be, for example, a pop-up window, and prompt information may be presented in a text manner in the pop-up window. In addition, the pop-up window may further carry a selection control for the user to select “agree” or “not agree” to provide personal information to the electronic device.

It may be understood that the above notification and process of obtaining a user authorization are merely illustrative, and do not constitute a limitation on implementations of the present disclosure, and other manners of meeting related laws and regulations may also be applied to implementations of the present disclosure.

As used herein, the term “model” may learn an association relationship between respective inputs and outputs from training data such that a corresponding output may be generated for a given input after training is completed. The generation of the model may be based on machine learning techniques. Deep learning is a machine learning algorithm that processes inputs and provides respective outputs by using a multi-layer processing unit. The neural network model is one example of a model based on deep learning. As used herein, a “model” may also be referred to as a “machine learning model,” a “learning model,” a “machine learning network,” or a “learning network,” these terms are used interchangeably herein.

A “neural network” is a machine learning network based on deep learning. The neural network is capable of processing inputs and providing respective outputs, which typically include an input layer and an output layer and one or more hidden layers between the input layer and the output layer. The neural network used in deep learning applications typically includes many hidden layers, such that a depth of the network may be increased. Each layer of the neural network is connected in sequence such that the output of the previous layer is provided as an input to the next layer, wherein the input layer receives the input of the neural network and the output of the output layer serves as a final output of the neural network. Each layer of the neural network includes one or more nodes (also referred to as a processing node or a neuron), each node processing the input from the previous layer.

As mentioned above, with the development of Internet information technology, network content has become an important carrier for information dissemination, entertainment leisure, and business activities. In order to improve loading speed of network content and shorten loading time, the provider of some network content selects to utilize a content delivery network (CDN) system for content distribution. CDN systems are typically charged by network traffic (e.g., downstream network traffic) generated by the provider.

The monthly 95th percentile bandwidth charging (P95) is a mainstream charging mode of the CDN system. A downlink network traffic of the provider is collected once every 5 minutes for a period of one month, 288 sampling points are counted every day, and the number of sampling points per month is equal to 288*(the number of charging days of the current month). All the sampling points are sorted in descending order of the downlink network traffic, the sampling points of top 5% in the sorting are removed, and the highest value of the downlink network traffic in the remaining sampling points in the sorting is the charging basic value of the current month. In this case, reducing the peak value of the network traffic will facilitate reducing the cost of use of the CDN system. However, peak values of the network traffic of various content distribution nodes in the CDN system are susceptible to various factors such as countries, regions, seasons, holidays, activities, and weather. Therefore, how to accurately control network traffic of each content distribution node to give consideration to both quality of experience (QoE) and return on investment (ROI) is necessary.

In view of this, embodiments of the present disclosure provide an improved solution for text processing. In this solution, a predicted network traffic for the content distribution node within a predetermined time period is determined. Based on the predicted network traffic, a content distribution mode of the content distribution node for the predetermined time period is determined, wherein the content distribution mode includes at least a first mode. Based on determining that the content distribution mode of the content distribution node is the first mode, and receiving a content access request from a terminal device, a first content item corresponding to the content access request is transmitted, via the content distribution node and to the terminal device, and the content distribution node is restrained from transmitting at least one second content item to be presented after the first content item to the terminal device.

In an embodiment of the present disclosure, the content distribution mode of the content distribution node is controlled according to the predicted network traffic of the content distribution node. When the predicted network traffic is high, the content distribution mode of the content distribution node may be determined as the first mode. When the content distribution node transmits the first content item to the terminal device, the content distribution node is restrained from pre-transmitting the second content item. In this way, the peak value of the network traffic can be reduced, and on the basis of ensuring the QoE, the ROI can also be considered.

Various example implementations of this scheme are described in detail below in conjunction with the accompanying drawings.

### Example Environment

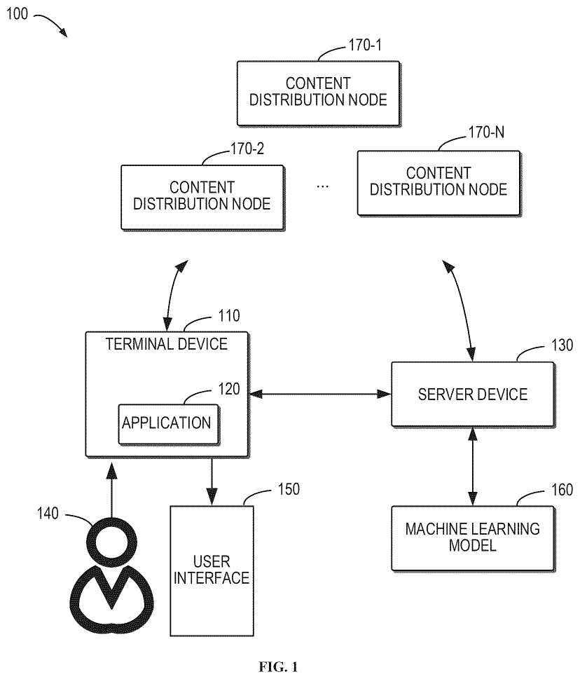

FIG. 1 illustrates a schematic diagram of an example environment 100 in which embodiments of the present disclosure can be implemented. In this example environment 100, an application 120 is installed in a terminal device 110. A user 140 may interact with the application 120 via the terminal device 110 and/or an attachment device of the terminal device 110.

In some embodiments of the present disclosure, the application 120 may be any suitable application capable of presenting content to the user. In some examples, if the application 120 is in an active state, the terminal device 110 may present the user interface 150 of the application 120. The user interface 150 may present, for example, live content, video content, image content, page content, textual content, and the like.

In some embodiments of the present disclosure, the environment 100 includes one or more content distribution nodes 170 (which may also be referred to as a CND node)., for example, which may include a content distribution node 170-1, a content distribution node 170-2, . . . , a content distribution node 170-N, and the like, wherein N is a positive integer. For ease of description, one or more content distribution nodes are collectively referred to herein as the content distribution node 170. The content distribution node 170 may store a content item provided by a provider, such as live content, video content, image content, page content, text content, and the like. In some embodiments, the content distribution node 170 may obtain the content item from a source station (e.g., a server device) of the provider and cache the obtained content at the content distribution node 170. In some embodiments, the content distribution node 170 may include one or more server devices, and the content distribution node 170 may cache the obtained content in the server device. In some embodiments, the one or more content distribution nodes 170 may be distributed in different countries or regions. The one or more content distribution nodes 170 may include content distribution nodes in one or more CDN systems. These content distribution nodes are configured to distribute content items of providers.

In some embodiments of the present disclosure, the terminal device 110 may send a content access request to the server device 130 to request access to one or more content items. The server device 130 may determine, from the one or more content distribution nodes 170, the content distribution node 170 that matches the terminal device 110, for example, the content distribution node 170 that is close to the terminal device 110, or the content distribution node 170 that is relatively low in load, according to information related to the terminal device 110 (for example, configuration information, geographic location, network status, and the like). In response to the content access request, the determined content distribution node provides a corresponding content item to the terminal device 110, and the terminal device 110 may present the accepted content item through the user interface 150.

In some embodiments, the server device 130 may utilize a machine learning model 160 to support provisioning of services to the application 120. In some embodiments, the machine learning model 160 may include a Transformer model, a long short-term memory network (LSTM) model, a recurrent neural network (RNN) model, or any other suitable model structure. In some embodiments, the machine learning model 160 may include a language model (LM). A machine learning model based on a language model can receive model inputs (e.g., natural language and/or machine language) of a text modality and/or model inputs (e.g., images, voice, videos, etc.) of a non-text modality, and can generate a desired output according to the model inputs and the prompt. The prompt herein is used to guide the machine learning model to generate a requirement indicated by the model input.

In some embodiments, the terminal device 110 may be any type of a mobile terminal, a fixed terminal, or a portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 can also support any type of interface for the user (such as a “wearable” circuit, etc.).

In some embodiments, the server device 130 may be independent of the CDN system and the content distribution node 170. For example, the server device 130 may be a server device associated with the provider. In some embodiments, the server device 130 may belong to a CDN system, or the server device 130 may belong to one content distribution node 170. The server device 130 may include, but is not limited to, a mainframe, an edge computing node, a computing device in a cloud environment, and the like. Which may be a independent physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server may include, for example, a computing system/server, such as a mainframe, an edge computing node, a computing device in a cloud environment, or the like.

It should be understood that the structures and functions of the various elements in the environment 100 are described for exemplary purposes only and do not imply any limitation to the scope of the present disclosure.

### Example Processes

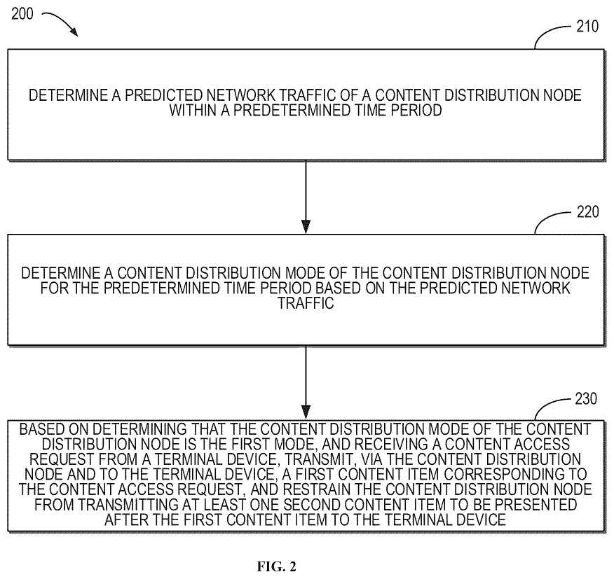

Some example embodiments of the present disclosure will be described below with continued reference to the accompanying drawings. FIG. 2 shows a flowchart of a control process 200 of a content distribution node according to some embodiments of the present disclosure. A portion or all of the process 200 may be implemented by a server device 130, or may be implemented by cooperation of the server device 130 and other devices, for example, may be implemented by cooperation of the server device 130 and a content distribution node 170. Hereinafter, for ease of discussion, the execution of the process 200 is described from the perspective of the server device 130, but this is merely exemplary.

At block 210, the server device 130 determines a predicted network traffic of the content distribution node 170 within a predetermined time period. In some embodiments, the predetermined time period may be a time period determined based on natural time such as a natural day, a natural hour, or the like. As an example, each natural day may be divided into 288 time periods per 5 minutes duration. The predetermined time period may be any one of the 288 time periods. In some embodiments, the predetermined time period may also be a time period formed by a predetermined duration after the current time, for example, a time period formed by 5 minutes after the current time. Of course, the above predetermined time period is merely exemplary, and the predetermined time period may be configured in other ways according to actual needs, which is not limited in the embodiments of the present disclosure.

In some embodiments, the predetermined network traffic may include all or a portion of network traffic that the content distribution node 170 may generate at the predetermined time period. In some examples, the predicted network traffic may include a content item in the content distribution node 170 associated with one or more predetermined providers, a predicted downlink network traffic generated within the predetermined time period. As an example, the content distribution node 170 may cache the content item from a source station of the application 120. The predetermined network traffic may be the predicted downlink network traffic generated by the content distribution node 170 transmitting the content items to one or more clients of the application 120 within the predetermined time period. In some embodiments, the predicted network traffic may also indicate a difference (also may be referred to as a residual network traffic) between the network traffic and a network bandwidth (or a network traffic limit value) that the content distribution node 170 may generate at the predetermined time period.

In some embodiments, the server device 130 may determine historical network traffic of the content distribution node 170 at the at least one historical time period corresponding to the predetermined time period, and may determine the predicted network traffic of the content distribution node 170 within the predetermined time period based on the historical network traffic of the at least one historical time period. In some examples, the predetermined time period may be a time period of an N-th 5 minutes duration of the current natural day. The at least one historical time period may include an N-th historical time period of each of the M-th historical natural days adjacent to the current natural day.

As an example, the at least one historical time period may include the N-th historical time period of each of seven historical natural days before the current natural day. The server device 130 may determine the historical network traffic of the content distribution node 170 within the seven historical time periods. Then, the predicted network traffic within the predetermined time period in the current natural day of the content is determined based on the historical network traffic for these seven historical time periods. Obviously, the historical network traffic within the historical time period is merely exemplary, and the predicted network traffic of the content distribution node 170 within any appropriate historical time period may be selected according to actual needs to determine the predicted network traffic within the predetermined time period.

In some embodiments, the server device 130 may determine the historical network traffic of the content distribution node 170 within the at least one historical time period corresponding to the predetermined time period. The model input for the trained machine learning model 160 is determined based on the historical network traffic for the at least one historical time period and reference information corresponding to the content distribution node 170. Then, based on the model input, the predicted network traffic is determined with the machine learning model 160. The machine learning model 160 herein may be trained to predict the predicted network traffic generated within a predetermined time period for predicting the content items of the content distribution node 170 related to a predetermined provider.

In some examples, the server device 130 may directly predict the predicted network traffic of the content distribution node 170 within the predetermined time period with the machine learning model 160. In other examples, the server device 130 may utilize the machine learning model 160 to predict a remaining network traffic of the content distribution node 170 at the predetermined time period, which may indicate a difference between the network traffic and the network bandwidth (or the network traffic limit) that the content distribution node 170 may generate within the predetermined time period. Thereafter, the server device 130 may determine the predicted network traffic based on the remaining network traffic.

As an example, the machine learning model 160 based on the Transformer model or the LSTM model may be pre-trained to determine the predicted network traffic. The predicted network traffic may be accurately determined with the trained machine learning model 160, which is beneficial to improving accuracy of control of the content distribution node 170. It should be noted that the machine learning model 160 is not limited to the above model architecture, it may also be formed based on any other suitable model architecture, and the type of the machine learning model 160 is not limited in the embodiments of the present disclosure.

In some embodiments, the server device 130 may determine, based on the historical network traffic for the at least one historical time period, at least one first label corresponding to the at least one historical time period, wherein each first label indicates whether historical network traffic of the corresponding historical time period falls within a first range or a second range, and the first range is higher than the second range. In addition, the server device 130 may further determine an index indicating a central tendency of the historical network traffic for the at least one historical time period. Then, the model input for the machine learning model 160 is determined based on the at least one first label, the index of the central tendency, and the reference information.

In some examples, the server device 130 may predetermine the first range and the second range for the network traffic, and the first range being higher than the second range. The first range may indicate a range of the network traffic within the content distribution node 170 that is within the peak time period for the content items related to the predetermined provider. The second range may indicate a range of network traffic within the content distribution node 170 that is within the non-peak time period for the content items related to the predetermined provider.

As an example, assuming that each charging period (for example, one natural month) includes K time periods, the CDN system samples the downlink network traffic generated by the content item of the predetermined provider at the content distribution node 170 within each time period (which may also be referred to as a sampling period), to obtain a sampling value of the downlink network traffic. The server device 130 may obtain K sampling values of the downlink network traffic within one or more historical charging periods (for example, a previous natural month). The K sampling values are sorted from high to low, the time period corresponding to the top X % (for example, 5%) of the sample value in the sort is determined as a peak time period, and a time period corresponding to the bottom (1−X)% (for example, 95%) of the sample value in the sort is determined as a non-peak time period. The server device 130 may determine the first range based on the sampling value of the peak time period. The server device may further determine the second range based on the sampling value of the non-peak time period. For example, the server device 130 may determine the network traffic range covered by the 5% of the sampling values as the first range, and may determine the network traffic range covered by the 95% of the sampling values as the second range. On this basis, the first range may actually indicate a network traffic level of the peak time period, or may be referred to as a peak range. The second range can actually indicate a network traffic level of the non-peak time period, which may also be referred to as a non-peak range. It should be further noted that since the network traffic level of the peak time period and the network traffic level of the non-peak time period may change dynamically, the first range and the second range may be updated irregularly during actual application, to ensure accuracy of the first range and the second range.

The server device 130 may compare the historical network traffic for each historical time period to the first range and the second range. If the historical network traffic falls within the first range, which means that the historical network traffic within the historical time period may belong to the peak network traffic, the first label indicating that the historical network traffic falls within the first range may be correspondingly generated. If the historical network traffic falls within the second range, which means that the historical network traffic within the historical time period may belong to the non-peak network traffic, the first label indicating that the historical network traffic falls within the second range may be correspondingly generated.

In some examples, the central tendency of the historical network traffic for the at least one historical time period may represent a central location or an average level of the historical network traffic for the at least one historical time period. On this basis, the index of the central tendency may include, but is not limited to, an arithmetic average, a geometric average, a harmonic mean, a median, and the like of the historical network traffic for the at least one historical time period. As an example, the server device 130 may determine the historical network traffic of the content distribution node 170 in each of the seven historical natural days, and determine an average value of the historical network traffic for these seven historical time days. Then, the average value is determined as an indicator indicating the central tendency of the historical network traffic for these seven historical time days.

In some examples, the reference information may include configuration information of the content distribution node 170. As an example, the configuration information may include, but is not limited to, at least one of location information and identification information of the content distribution node 170. The location information may indicate a country and/or region in which the content distribution node 170 is located. The identification information may include, for example, a name, a number, or the like of the content distribution node 170. Apparently, the configuration information is not limited to including the location information and the identification information, which may also include other relevant information of the content distribution node 170, which is not limited in the embodiments of the present disclosure.

Alternatively or additionally, the reference information may further include a second label indicating whether the predetermined time period falls within a particular time frame. The particular frame may include a frame of correlation between the network traffic changes with the content distribution node 170, such as holidays, vacations, anniversaries, activity days of particular activities, and so forth. As an example, the reference information may include a second label indicating whether the predetermined time period falls within a holiday.

Referring to FIG. 2, at block 220, the server device 130 determines a content distribution mode of a content distribution node 170 for a predetermined time period based on a predicted network traffic. In some embodiments, the content distribution mode may be a distribution mode for all or portion of the content items in the content distribution node 170. In some examples, the content distribution mode may be a distribution mode for content items in the content distribution node 170 related to a predetermined provider. For example, the content distribution mode may be directed to a distribution mode of content items in the content distribution node 170 related to the application 120. In some examples, the content distribution mode may be a distribution mode for a particular content item in the content distribution node 170. As an example, the content distribution mode may be directed to a distribution mode of a live content item in the content distribution node 170 related to an application 120. The content distribution node 170 may be configured to transmit the live content item to a client of the application 120 based on the content distribution mode.

In some embodiments, the content distribution mode may include a first mode, which may be a content distribution mode for a peak time period of the network traffic. The server device 130 may determine whether the predicted network traffic falls within the first range (i.e., a peak range). If it is determined that the predicted network traffic falls within the first range, it indicates that the predetermined time period may be the peak time period of the current charging period (e.g., the current month). The server device 130 may determine that the content distribution mode of the content distribution node 170 is the first mode.

In some embodiments, the content distribution mode may also include a second mode, which may be a content distribution mode for a non-peak time period. The server device 130 may determine whether the predicted network traffic falls within the second range (i.e., a non-peak range). If it is determined that the predicted network traffic falls within the second range, it indicates that the predetermined time period may be the non-peak time period of the current charging period. The server device 130 may determine that the content distribution mode of the content distribution node 170 is the second mode.

In some embodiments, the server device 130 may determine the content distribution mode based on a difference (also referred to as a remaining network traffic) between the predicted network traffic and a network traffic limit of the content distribution node 170. In some examples, the network traffic limit may include a network bandwidth of the content distribution node 170. In some other examples, the server device 130 may determine the network traffic limit based on a peak value of the network traffic for the plurality of historical charging periods, an upper limit value or a lower limit value of the network traffic of the peak time period, an upper limit value of the non-peak time period, and the like. As an example, the server device 130 may determine the network traffic limit based on the upper limit value of the plurality of non-peak time periods for the plurality of historical charging periods. In this way, the height of the peak value of the network traffic of the content distribution node 170 can be limited to a certain extent, which is beneficial to reduce the operation cost.

In some examples, the server device 130 may predetermine a third range corresponding to the peak time period and a fourth range corresponding to the non-peak time period. The server device 130 may determine whether the remaining network traffic falls within a third range or a fourth range. If it is determined that the remaining network traffic falls within the third range, the server device 130 determines that the content distribution mode of the content distribution node 170 for the predetermined time period is the first mode. If it is determined that the remaining network traffic falls within the fourth range, the server device 130 determines that the content distribution mode of the content distribution node 170 for the predetermined time period is the second mode.

In some embodiments, the server device 130 may correct the predicted network traffic based on a correction coefficient corresponding to the predetermined time period, to obtain a corrected predicted network traffic. The server device 130 may determine, based on the corrected predicted network traffic, a content distribution mode of the content distribution node 170 for a predetermined time period. In some examples, the correction coefficient may be configured to modify the predicted network traffic to reduce the difference between the predicted network traffic and real network traffic and improve the accuracy of the determination of the content distribution pattern. In other examples, the correction coefficient may also be configured to modify the predicted network traffic to increase the value of the predicted network traffic, thereby reserving a certain network traffic margin, and limiting the height of the peak value of the network traffic.

In some examples, the server device 130 may determine historical network traffic for a plurality of historical time periods corresponding to the predetermined time period. Then, the correction coefficient corresponding to the predetermined time period is determined based on a ratio between a number of historical time periods among the plurality of historical time periods with the historical network traffic fall within the first range and a total number of the plurality of historical time periods. As an example, the server device 130 may determine the historical network traffic of K historical time periods in the historical charging period. A number that the K historical network traffic falls within the first range is determined, for example, the number may be expressed as L. The server device 130 may determine a ratio between L and K, and then determine a correction coefficient a based on the ratio, for example, the ratio may be used as the correction coefficient a. The server device 130 may obtain the corrected predicted network traffic based on the predicted network traffic*(1+a). It should be understood that the manner of determining the correction coefficient and the manner of correcting the predicted network traffic are merely exemplary, other manners may be used to determine the correction coefficient, or other manners may also be used to correct the predicted network traffic, and the embodiments of the present disclosure are not limited in this respect.

With continued reference to FIG. 2, in block 230, the server device 130 transmits, via the content distribution node 170 and to the terminal device 110, a first content item corresponding to the content access request, and restrains the content distribution node from transmitting at least one second content item to be presented after the first content item to the terminal device based on determining that the content distribution mode of the content distribution node 170 is the first mode, and receiving the content access request from the terminal device 110. The first content item may be understood as a content item currently accessed by the terminal device 110. The at least one second content item may be understood as a content item to be presented by the terminal device 110 in the future. For example, when the terminal device 110 presents the first content item, if the terminal device 110 receives a switching operation (for example, sliding, clicking, etc.) on the content item, the terminal device 110 will present one of the at least one second content item.

While the first content item is transmitted to the terminal device 110, the transmission of the second content item may also be referred to as parallel transmission or pre-transmission. The first content item and the second content item are transmitted to the terminal device 110 in parallel via the content distribution node 170 in order to improve the fluency of presenting the content item, but which may increase the network traffic of the content distribution node 170. In a case that it is determined that the predetermined time period may be the peak value time period of the current charging period, the content distribution node 170 is restrained from transmitting the second content item in parallel with the first content item by setting the content distribution node 170 to the first mode. In this way, it is beneficial to reduce the network traffic of the content distribution node 170 in the predetermined time period, thereby helping to reduce the height of the peak value of the network traffic in the current charging period, which is beneficial to reducing the operation cost.

In some embodiments, in the case that the content distribution mode of the content distribution node 170 is determined, the server device 130 may modify the configuration information of the content distribution node 170 to set the content distribution mode of the content distribution node 170 to the first mode. For example, the server device 130 may add the first label indicating the first mode in the configuration information of the content distribution node 170. If the content access request of the terminal device 110 is received, the first content item and the at least one second content item corresponding to the content access request are determined. If it is determined, based on the first tag, that the content distribution node 170 is in the first mode, the content distribution node 170 transmits the first content item to the terminal device 110, and does not transmit the second content item in parallel with the first content item. In some examples, restraining the content distribution node 170 from transmitting the second content item to the terminal device 110 may be restraining the content distribution node 170 from transmitting all or portion of the content of the second content item to the terminal device 110.

In some embodiments, the content distribution mode may be a distribution mode for content items in the content distribution node related to the predetermined provider. In this case, the server device 130 restrains the content distribution node 170 from transmitting the second content item related to the predetermined provider to the terminal device 110. As an example, the content distribution mode may be a distribution mode for the application 120. In the case that it is determined that the content distribution node 110 is in the first mode, the content distribution node 170 sends the first content item to the terminal device 110, for the application 120 to present in a current user interface 150, and restrains the content distribution node 170 from sending, to the terminal device 110, the second content item for the application 130 to present in the future.

In some embodiments, the content distribution mode may be a distribution mode for a particular content item in the content distribution node 170, which may be a relatively large content item of the required network traffic. If it is determined that the content distribution node 170 is in the first mode, one or more particular content items in the at least one second content item and the remaining second content items are determined, the first content item and the remaining second content items are transmitted to the terminal device 110 via the content distribution node 170, and the content distribution node 170 is restrained from transmitting the one or more particular content items to the terminal device 110. In this way, the QoE and the ROI can be considered to a certain extent.

As an example, in some display modes, the application 120 may mix and arrange a short video and the live content through the content container. If the content access request of the terminal device 110 is received, and it is determined that the content distribution node 170 corresponding to the terminal device 110 is in the first mode, the short video or the live content (that is, the first content item) corresponding to the access request is transmitted to the terminal device 110, and the content distribution node 170 is restrained to transmit the live content in the at least one second content item to the terminal device 110, to reduce network traffic consumption.

In some embodiments, if it is determined that the content distribution mode of the content distribution node 170 is the second mode, and the content access request is received from the terminal device 110, transmitting the first content item and the at least one second content item to the terminal device via the content distribution node. Specifically, if it is determined that the predetermined time period may be the non-peak time period, the server device 130 may set the content distribution mode of the content distribution node 170 to the second mode, for example, the server device 130 may add the second label indicating the second mode in the configuration information of the content distribution node 170. If the content access request of the terminal device 110 is received, and it is determined that the content distribution node 170 is in the second mode, it denotes that the remaining network traffic of the content distribution node 170 is abundant, the first content item and the at least one second content item may be transmitted in parallel, and the QoE may be preferentially ensured.

In this way, in an embodiment of the present disclosure, the content distribution mode of the content distribution node is controlled according to the predicted network traffic of the content distribution node. When the predicted network traffic is high, the content distribution mode of the content distribution node may be determined as the first mode. While the content distribution node transmits the first content item to the terminal device, the content distribution node is restrained from pre-transmitting the second content item. In this way, the peak value of the network traffic can be reduced, and on the basis of ensuring the QoE, the ROI can also be considered.

### Example Apparatus and Device

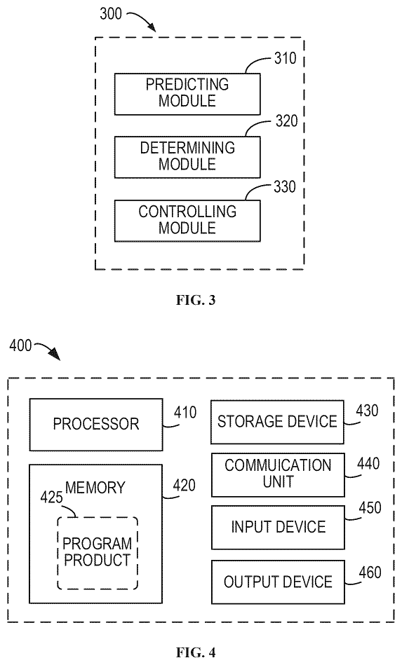

Embodiments of the present disclosure also provide a corresponding apparatus for implementing the above method or process. FIG. 3 shows a schematic structural block diagram of an example apparatus 300 for controlling a content distribution node according to some embodiments of the present disclosure. The apparatus 500 may be implemented or included in the server device 130. The various modules/components in the apparatus 300 may be implemented by hardware, software, firmware, or any combination thereof.

As shown in FIG. 3, the apparatus 300 includes: a predicting module 310 configured to determine a predicted network traffic of the content distribution node within a predetermined time period; a determining module 320 configured to determine, based on the predicted network traffic, a content distribution mode for the content distribution node in the predetermined time period, wherein the content distribution mode comprises at least a first mode; a control module 330 configured to, based on determining that the content distribution mode of the content distribution node is the first mode, and receiving a content access request from a terminal device, transmit, via the content distribution node and to the terminal device, a first content item corresponding to the content access request, and restrain the content distribution node from transmitting at least one second content item to be presented after the first content item to the terminal device.

In some embodiments, the prediction module 310 is further configured to: determine a historical network traffic of the content distribution node within at least one historical time period corresponding to the predetermined time period; determine a model input for a machine learning model based on the historical network traffic for the at least one historical time period and reference information corresponding to the content distribution node; and determine the predicted network traffic with the machine learning model based on the model input.

In some embodiments, the predicting module 310 is further configured to: determine, based on the historical network traffic for the at least one historical time period, at least one first label corresponding to the at least one historical time period, wherein each first label indicates whether historical network traffic of a corresponding historical time period falls within a first range or a second range, and the first range is higher than the second range; determine an index indicating a central tendency of the historical network traffic for the at least one historical time period; and determine the model input based on the at least one first label, the index, and the reference information.

In some embodiments, the reference information includes at least one of the following: configuration information of the content distribution node, or a second label indicating whether the predetermined time period falls within a particular time frame.

In some embodiments, the determining module 320 is further configured to: correct the predicted network traffic based on a correction coefficient corresponding to the predetermined time period, to obtain a corrected predicted network traffic; and determine, based on the corrected predicted network traffic, the content distribution mode of the content distribution node for the predetermined time period.

In some embodiments, the determining module 320 is further configured to: determine historical network traffic for a plurality of historical time periods corresponding to the predetermined time period; and determine the correction coefficient corresponding to the predetermined time period, based on a ratio between a number of historical time periods among the plurality of historical time periods with the historical network traffic fall within the first range and a total number of the plurality of historical time periods.

In some embodiments, the content distribution mode further includes a second mode, and the control module 330 is further configured to: based on determining that the content distribution mode of the content distribution node is the second mode, and receiving a content access request from the terminal device, transmit the first content item and the at least one second content item to the terminal device via the content distribution node.

In some embodiments, the determining module 320 is further configured to: determine, in response to the predicted network traffic falling within a first range, that a content distribution mode of the content distribution node for the predetermined time period is the first mode, or determine, in response to the predicted network traffic falling within a second range below the first range, that a content distribution mode of the content distribution node for the predetermined time period is the second mode.

In some embodiments, the determining module 320 is further configured to determine the content distribution mode based on a difference between the predicted network traffic and a network traffic limit for the content distribution node.

The units and/or modules included in the apparatus 300 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, part or all of the units and/or modules in the apparatus 300 may be implemented, at least in part, by one or more hardware logic components. By way of example and not limitation, exemplary types of hardware logic components that may be used include field programmable gate arrays (FPGAs), application specific integrated circuits (ASICs), application specific standard products (ASSPs), system-on-a-chip (SOCs), complex programmable logic devices (CPLDs), and the like.

FIG. 4 illustrates a block diagram of an electronic device 410 in which one or more embodiments of the present disclosure may be implemented. It should be understood that the electronic device 410 illustrated in FIG. 4 is merely exemplary and should not constitute any limitation on the functionality and scope of the embodiments described herein. The electronic device 410 shown in FIG. 4 may include or be implemented as the server device 130 of FIG. 1, and the device 300 of FIG. 3.

As shown in FIG. 4, the electronic device 410 is in the form of a general-purpose electronic device. The components of the electronic device 410 may include, but are not limited to, one or more processors 410, a memory 420, a storage device 430, one or more communication units 440, one or more input devices 450, and one or more output devices 460. The processor 410 may be an actual or virtual processor and capable of performing various processes according to executable instructions stored in the memory 420. In multiprocessor systems, multiple processors execute computer-executable instructions in parallel to improve parallel processing capability of the electronic device 410.

Electronic device 410 typically includes a plurality of computer storage media. Such media may be any available media accessible to the electronic device 410, including, but not limited to, volatile and non-volatile media, removable and non-removable media. The memory 420 may be volatile memory (e.g., a register, a cache, a random access memory (RAM)), a non-volatile memory (e.g., read-only memory (ROM), an electrically erasable programmable read-only memory (EEPROM), a flash memory), or some combination thereof. A storage device 430 may be a removable or non-removable medium and may include a machine-readable medium, such as a flash drive, a magnetic disk, or any other medium, which may be capable of storing information and/or data and may be accessed within electronic device 410.

The electronic device 410 may further include additional removable/non-removable, volatile/non-volatile storage media. Although not shown in FIG. 4, a disk drive for reading or writing from a removable, non-volatile magnetic disk (e.g., a “floppy disk”) and an optical disk drive for reading or writing from a removable, non-volatile optical disk may be provided. In these cases, each drive may be connected to a bus (not shown) by one or more data media interfaces. The memory 420 may include a computer program product 425 having one or more executable instruction modules configured to perform various methods or actions of various embodiments of the present disclosure.

The communication unit 440 is configured to communicate with another electronic device through a communication medium. Additionally, the functionality of components of the electronic device 410 may be implemented in a single computing cluster or multiple computing machines capable of communicating over a communication connection. Thus, the electronic device 410 may operate in a networked environment using logical connections with one or more other servers, network personal computers (PCs), or another network node.

The input device 450 may be one or more input devices such as a mouse, a keyboard, a trackball, or the like. The output device 460 may be one or more output devices, such as a display, a speaker, a printer, or the like. The electronic device 410 may also communicate with one or more external devices (not shown) through the communication unit 440 as needed, the external devices such as storage devices, display devices, etc., communicate with one or more devices that enable a user to interact with the electronic device 410, or communicate with any device (e.g., a network card, a modem, etc.) that enables the electronic device 410 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, there is further provided a computer executable instruction product tangibly stored on a non-transitory computer readable medium and including computer executable instructions that are executed by a processor to implement the method described above.

Aspects of the disclosure are described herein with reference to flowcharts and/or block diagrams of methods, apparatuses, devices, and computer-executable instruction products implemented in accordance with the present disclosure. It should be understood that each block of the flowchart and/or block diagrams, and combinations of blocks in the flowcharts and/or block diagrams, may be implemented by computer-readable executable instruction instructions.

These computer-executable instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-executable instructions may also be stored in a computer-readable storage medium that cause a computer, programmable data processing device, and/or other device to function in a particular manner, such that the computer-readable medium storing instructions includes an article of manufacture including instructions to implement aspects of the functions/acts specified in the flowchart and/or block diagram(s).

The computer-executable instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer-executable instruction products according to various implementations of the present disclosure. In this regard, each block in the flowcharts or block diagrams may represent a module, a portion of an executable instruction or an instruction, a module, executable instructions, or a portion of an instruction including one or more executable instructions for implementing a specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowcharts, may be implemented with a dedicated hardware-based system that performs the specified functions or actions, or may be implemented in a combination of dedicated hardware and computer instructions.

Various implementations of the present disclosure have been described above, and the above descriptions are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for controlling a content distribution node, comprising:
determining a predicted network traffic of the content distribution node within a predetermined time period;
determining, based on the predicted network traffic, a content distribution mode of the content distribution node for the predetermined time period, wherein the content distribution mode comprises at least a first mode;
based on determining that the content distribution mode of the content distribution node is the first mode, and receiving a content access request from a terminal device,
transmitting, via the content distribution node and to the terminal device, a first content item corresponding to the content access request, and
restraining the content distribution node from transmitting at least one second content item to be presented after the first content item to the terminal device.

2. The method of claim 1, wherein determining the predicted network traffic comprises:
determining a historical network traffic of the content distribution node within at least one historical time period corresponding to the predetermined time period;
determining a model input for a machine learning model based on the historical network traffic for the at least one historical time period and reference information corresponding to the content distribution node; and
determining the predicted network traffic with the machine learning model based on the model input.

3. The method of claim 2, wherein determining the model input comprises:
determining, based on the historical network traffic for the at least one historical time period, at least one first label corresponding to the at least one historical time period, wherein each first label indicates whether historical network traffic of a corresponding historical time period falls within a first range or a second range, and the first range is higher than the second range;
determining an index indicating a central tendency of the historical network traffic for the at least one historical time period; and
determining the model input based on the at least one first label, the index, and the reference information.

4. The method of claim 2, wherein the reference information comprises at least one of the following:
configuration information of the content distribution node, or
a second label indicating whether the predetermined time period falls within a particular time frame.

5. The method of claim 1, wherein determining the content distribution mode comprises:
correcting the predicted network traffic based on a correction coefficient corresponding to the predetermined time period, to obtain a corrected predicted network traffic; and
determining, based on the corrected predicted network traffic, the content distribution mode of the content distribution node for the predetermined time period.

6. The method of claim 5, further comprising:
determining historical network traffics for a plurality of historical time periods corresponding to the predetermined time period; and
determine the correction coefficient corresponding to the predetermined time period, based on a ratio between a number of historical time periods among the plurality of historical time periods with the historical network traffics fall within the first range and a total number of the plurality of historical time periods.

7. The method of claim 1, wherein the content distribution mode further comprises a second mode, and the method further comprises:
based on determining that the content distribution mode of the content distribution node is the second mode, and receiving a content access request from the terminal device,
transmitting the first content item and the at least one second content item to the terminal device via the content distribution node.

8. The method of claim 7, wherein determining the content distribution pattern comprises:
determining, in response to the predicted network traffic falling within a first range, that a content distribution mode of the content distribution node for the predetermined time period is the first mode, or
determining, in response to the predicted network traffic falling within a second range below the first range, that a content distribution mode of the content distribution node for the predetermined time period is the second mode.

9. The method of claim 1, wherein determining the content distribution mode comprises:
determining the content distribution mode based on a difference between the predicted network traffic and a network traffic limit for the content distribution node.

10. An electronic device, comprising:
at least one processor; and
at least one memory coupled to the at least one processor and storing instructions for execution by the at least one processor, the instructions, when executed by the at least one processor, causing the electronic device to perform acts comprising:
determining a predicted network traffic of the content distribution node within a predetermined time period;
determining, based on the predicted network traffic, a content distribution mode of the content distribution node for the predetermined time period, wherein the content distribution mode comprises at least a first mode;
based on determining that the content distribution mode of the content distribution node is the first mode, and receiving a content access request from a terminal device,
transmitting, via the content distribution node, a first content item corresponding to the content access request to the terminal device, and
restraining the content distribution node from transmitting at least one second content item to be presented after the first content item to the terminal device.

11. The electronic device of claim 10, wherein determining the predicted network traffic comprises:
determining a historical network traffic of the content distribution node within at least one historical time period corresponding to the predetermined time period;
determining a model input for a machine learning model based on the historical network traffic for the at least one historical time period and reference information corresponding to the content distribution node; and
determining the predicted network traffic with the machine learning model based on the model input.

12. The electronic device of claim 10, wherein determining the model input comprises:
determining, based on the historical network traffic for the at least one historical time period, at least one first label corresponding to the at least one historical time period, wherein each first label indicates whether historical network traffic of a corresponding historical time period falls within a first range or a second range, and the first range is higher than the second range;
determining an index indicating a central tendency of the historical network traffic for the at least one historical time period; and
determining the model input based on the at least one first label, the index, and the reference information.

13. The electronic device of claim 10, wherein the reference information comprises at least one of the following:
configuration information of the content distribution node, or
a second label indicating whether the predetermined time period falls within a particular time period.

14. The electronic device of claim 10, wherein determining the content distribution mode comprises:
correcting the predicted network traffic based on a correction coefficient corresponding to the predetermined time period, to obtain a corrected predicted network traffic; and
determining, based on the corrected predicted network traffic, the content distribution mode of the content distribution node for the predetermined time period.

15. The electronic device of claim 10, wherein the acts further comprise:
determining historical network traffics for a plurality of historical time periods corresponding to the predetermined time period; and
determine the correction coefficient corresponding to the predetermined time period, based on a ratio between a number of historical time periods among the plurality of historical time periods with the historical network traffics fall within the first range and a total number of the plurality of historical time periods.

16. The electronic device of claim 10, wherein the content distribution mode further comprises a second mode, and the acts further comprise:
based on determining that the content distribution mode of the content distribution node is the second mode, and receiving a content access request from the terminal device,
transmitting the first content item and the at least one second content item to the terminal device via the content distribution node.

17. The electronic device of claim 10, wherein determining the content distribution pattern comprises:
determining, in response to the predicted network traffic falling within a first range, that a content distribution mode of the content distribution node for the predetermined time period is the first mode, or
determining, in response to the predicted network traffic falling within a second range below the first range, that a content distribution mode of the content distribution node for the predetermined time period is the second mode.

18. The electronic device of claim 10, wherein determining the content distribution mode comprises:
determining the content distribution mode based on a difference between the predicted network traffic and a network traffic limit for the content distribution node.

19. A non-transitory computer-readable storage medium having computer-executable instructions stored thereon which are executable by a processor to implement acts comprising:
determining a predicted network traffic of the content distribution node within a predetermined time period;
determining, based on the predicted network traffic, a content distribution mode of the content distribution node for the predetermined time period, wherein the content distribution mode comprises at least a first mode;
based on determining that the content distribution mode of the content distribution node is the first mode, and receiving a content access request from a terminal device,
transmitting, via the content distribution node, a first content item corresponding to the content access request to the terminal device, and
restraining the content distribution node from transmitting at least one second content item to be presented after the first content item to the terminal device.

20. The non-transitory computer-readable storage medium of claim 19, wherein determining the predicted network traffic comprises:
determining a historical network traffic of the content distribution node within at least one historical time period corresponding to the predetermined time period;
determining a model input for a machine learning model based on the historical network traffic for the at least one historical time period and reference information corresponding to the content distribution node; and
determining the predicted network traffic with the machine learning model based on the model input.
